(19) United States
(12) Patent Application Publication
(10) Pub. No.: US 2011/0211804 A1
(43) Pub. Date: Sep. 1, 2011

(54) VIDEO DISPLAY DEVICE

(75) Inventors: Taku Yamamoto, Fujisawa (JP); Yoshiyuki Akazawa, Yokohama (JP); Ken Tsukamoto, Yokohama (JP); Koichi Sugimoto, Yokohama (JP)

(73) Assignee: HITACHI CONSUMER ELECTRONICS CO., LTD.

(21) Appl. No.: 12/912,887

(22) Filed: Oct. 27, 2010

(30) Foreign Application Priority Data
Feb. 26, 2010 (JP) 2010-042134

(51) Int. Cl. H04N 5/775

(52) U.S. Cl. 386/230; 386/E05.003

(57) ABSTRACT

The present invention provides a video display device provided with a storage mechanism that reliably holds a recording medium (HDD) with the reduced number of components. A tray integrally stores an installed HDD built in the device and a cassette HDD attachable to and detachable from the device, and is mounted on a main chassis. An HDD stopper of a hook-like shape integrated with the tray presses an end part of the installed HDD to secure its storage position. An HDD holder integrated with the tray presses a side surface at an end part of the cassette HDD to prevent it from falling off the tray. Further, a regulating plate formed by cutting and raising the main chassis suppresses deformation of the HDD stopper, and an anti-falling plate prevents the installed HDD from falling off the tray.

### CLAIM OF PRIORITY

The present application claims priority from Japanese patent application serial No. JP 2010-042134, filed on Feb. 26, 2010, the content of which is hereby incorporated by reference into this application.

### BACKGROUND OF THE INVENTION

(1) Field of the Invention

The present invention relates to a video display device which has a built-in recording medium and which can record, for example, a received broadcast program.

(2) Description of the Related Art

Widely known is a video display device (television device) which has a built-in large-capacity recording medium such as an HDD (Hard Disk Drive) and which can record, for example, a received broadcast program. The HDD as the recording medium in this case is typically of an installed type that is secured inside the device for use, but a video display device that can be used with a portable cassette HDD attached to and detached from the device has also been put into practical use. The cassette HDD is also called iVDR (abbreviation of Information Versatile Disk for Removable usage, and a registered trademark meaning a technical standard of iVDR Consortium).

JP-A-2008-153959 describes a recording guidance function provided with excellent convenience and user-friendliness as a result of improving operability in a broadcast receiving device to which a cassette HDD can be fitted together with an installed HDD. For example, upon execution of reserved recording on the cassette HDD (iVDR), in a case where the cassette HDD is not fitted, the recording of a reserved program is performed on the installed-type HDD.

### SUMMARY OF THE INVENTION

Fitting the two recording media including the installed HDD and the cassette HDD to one video display device result in a complicated storage mechanism for storing the HDDs and holding them at predetermined positions. Moreover, simply speaking, the number of components to be mounted increases doubly accordingly, leading to an increase in component costs. On the other hand, an unsatisfactory method of securing the HDDs in the storage mechanism causes reliability-related problems, for example, a problem that the HDDs easily fall off a storage part. In the conventional art starting with that in JP-A-2008-153959 described above, no special attention has been given to the storage mechanism for reliably holding the two recording media (HDDs) in a strategical manner.

The present invention has been made in view of the problems described above, and it is an object of the invention to provide a video display device provided with a storage mechanism that reliably holds a recording medium with the reduced number of components.

One aspect of the invention refers to a video display device displaying an inputted video signal at a display and also having a recording and playback part recording and playing back the inputted video signal. The video display device includes: a tray integrally storing as the recording and playback part, a first recording medium built in the device and a second recording medium attachable to and detachable from the device; and a main chassis having a processing board for the video signal mounted thereon together with the tray. A stopper of a hook-like shape integrated with the tray is provided at an end part of the tray. An end part of the first recording medium is pressed by the stopper to secure a storage position of the first recording medium.

Part of the main chassis may be cut and raised to provide a regulating plate, and deformation of the stopper provided at the tray may be suppressed by the regulating plate. Part of the main chassis may be cut and raised to provide an anti-falling plate, and the first recording medium stored on the tray may be prevented by the anti-falling plate from falling off the tray. A holder integrated with the tray may be provided at the tray, and a side surface at an end part of the second recording medium may be pressed by the holder to prevent the second recording medium from falling off the tray.

The invention can provide a video display device provided with a storage mechanism that reliably holds a recording medium with the reduced number of components.

### BRIEF DESCRIPTION OF THE DRAWINGS

These and other features, objects and advantages of the present invention will become more apparent from the following description when taken in conjunction with the accompanying drawings wherein:

FIG. 1A is an external diagram (frond side) showing one embodiment of a video display device of the invention;

FIG. 1B is an external diagram (rear side) showing one embodiment of the video display device of the invention;

FIG. 2 is an internal configuration diagram of the video display device of FIG. 1B, with a rear cover 2 removed;

FIG. 3 is a block diagram of a signal system of the video display device of this embodiment;

FIG. 4A is a general view of the surroundings of a recording and playback part 8, showing a state in which only an installed HDD 31 is fitted;

FIG. 4B is a general view of the surroundings of the recording and playback part 8, showing a state in which both the installed HDD 31 and a cassette HDD 32 are fitted;

FIG. 5A is an exploded view of the recording and playback part 8, showing a state in which a relay board 9 is fitted to a tray 20;

FIG. 5B is an exploded view of the recording and playback part 8, showing a state in which the installed HDD 31 and the cassette HDD 32 are fitted to the tray 20 of FIG. 5A;

FIG. 5C is an exploded view of the recording and playback part 8, showing a shape of a main chassis 10;

FIG. 6A is a diagram illustrating anti-falling of the installed HDD 31 and the cassette HDD 32 and also a plan view of the recording and playback part 8;

FIG. 6B shows diagrams illustrating the anti-falling of the installed HDD 31 and the cassette HDD 32 and also sectional views taken along line X-X of FIG. 6A;

FIG. 7A is a diagram illustrating prevention of foreign substance entry to the tray 20 and a perspective view of a portion of the tray 20 where a tip of the cassette HDD 32 is fitted;

FIG. 7B is a diagram illustrating the prevention of the foreign substance entry to the tray 20 and a perspective view with the tray 20 of FIG. 7A mounted on the chassis 10; and

FIG. 7C shows diagrams illustrating the prevention of the foreign substance entry to the tray 20 and sectional views taken along line Y-Y of FIG. 7B.

### DETAILED DESCRIPTION OF THE EMBODIMENT

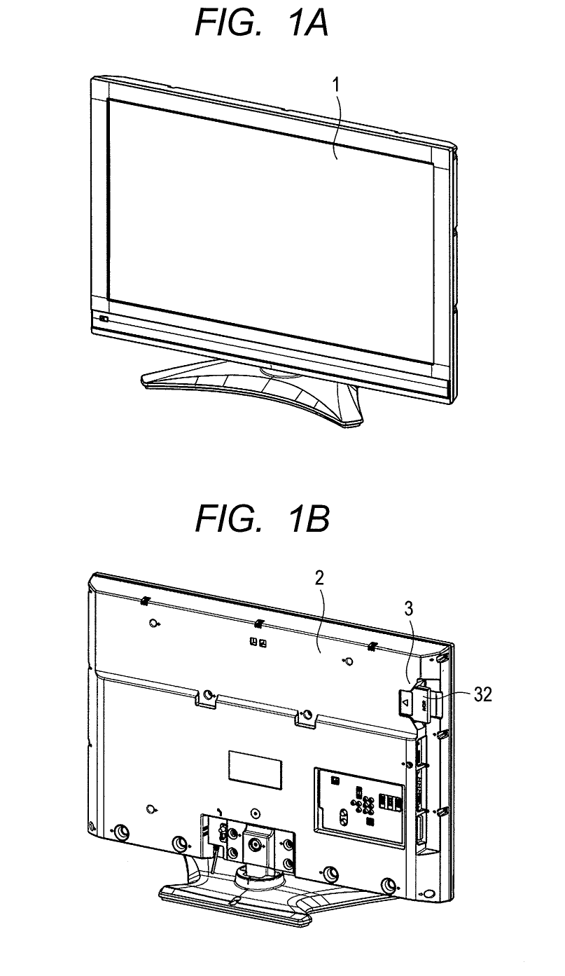

Hereinafter, an embodiment of the present invention will be described with reference to the accompanying drawings. FIGS. 1A and 1B are external diagrams showing one embodiment of a video display device of the invention, viewed from a front side and a rear side, respectively. For a display 1 displaying a video, for example, a liquid crystal display panel is used, and at a device-side surface of the rear cover 2, an insertion port 3 for attaching and detaching a cassette HDD (iVDR) 32 for recording is provided. Thus, the video display device of this embodiment has the function of recording and playing back a received broadcast program by use of the attached cassette HDD together with a built-in installed HDD.

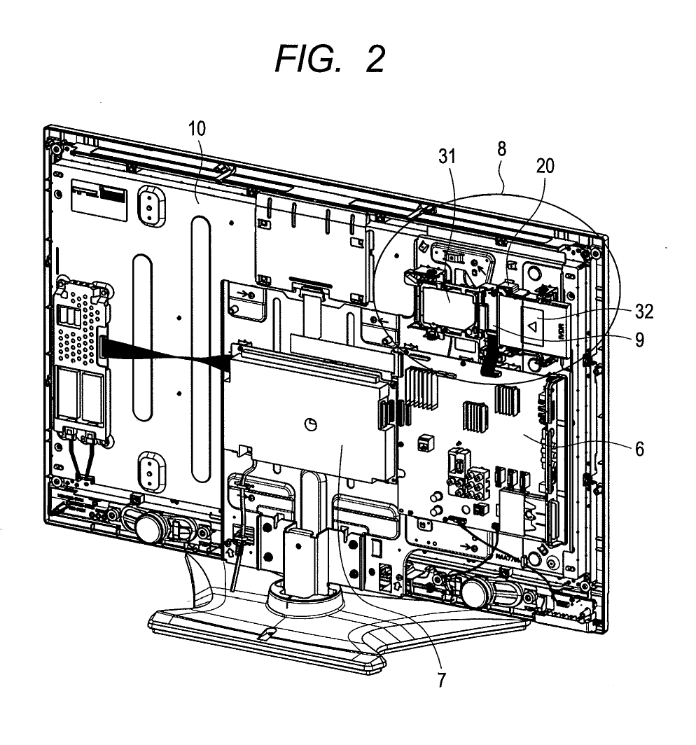

FIG. 2 is an internal configuration diagram of the video display device of FIG. 1B, with the rear cover 2 removed. A main chassis 10 is formed of metal, for example, aluminum or iron, and so structured as to support and reinforce a rear surface of the device. Loaded in the main chassis 10 are a main board 6 processing a video signal and a power supply board 7 and also a recording and playback part 8, to which the installed HDD 31 and the cassette HDD 32 are fitted as recording media. Upon this fitting, the installed HDD 31 and the cassette HDD 32 are stored in one storage mechanism (hereinafter called tray 20) and mounted on the main chassis 10. The fitted installed HDD 31 and cassette HDD 32 are connected to the main board 6 including signal circuits via the relay board 9.

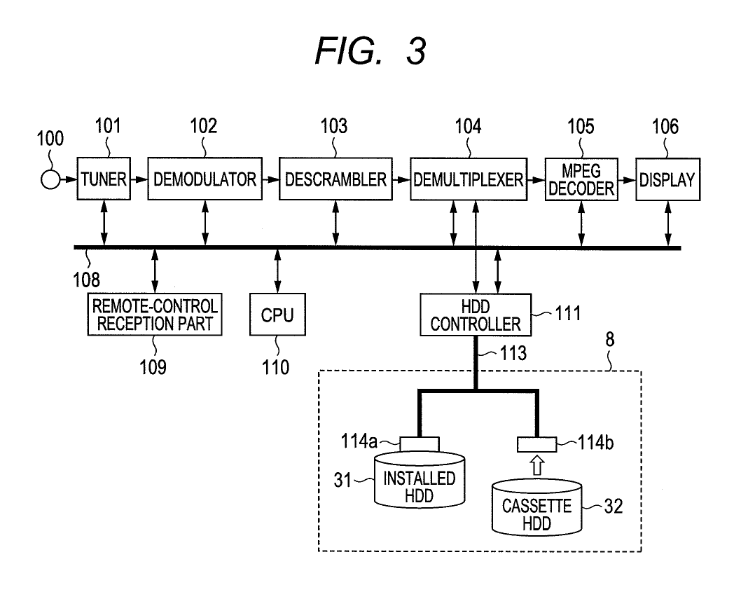

FIG. 3 is a block diagram of a signal system of the video display device of this embodiment. To an input terminal 100, airwaves from an antenna are supplied, and at a tuner 101, the user selects a desired broadcast channel. In the channel selection, for example, remote control operation directions provided by the user are received at a remote control reception part 109 to control the tuner 101. At a demodulator 102, demodulation is performed in accordance with a modulation method used for transmission and also an error that occurred during the transmission is corrected. At a descrambler 103, a secret code provided at a broadcast station is decoded, and at a demultiplexer 104, video/voice contents desired by the user are separated from a plurality of programs subjected to time-division multiplexing. At an MPEG decoder 105, compression and coding performed on the video/voice contents by an MPEG method are extended and decoded. A decoded video/voice signal is transmitted to a display 106/a speaker, so that the user views it. A CPU 110 controls operation of various parts via a bus 108. These signal processing circuits are stored in the main board 6.

The recording and playback part 8 is fitted with: the installed HDD 31 securely provided inside of the device; and the cassette HDD (iVDR) 32 attachable and detachable by the user. The installed HDD 31 is connected to a connector 114a, the cassette HDD 32 is connected to a connector 114b, and the both are connected to an HDD controller 111 via a bus 113. Whether to use the installed HDD 31 or the cassette HDD 32 as a recording destination is selected through operation of a remote controller by the user. Further, it is also possible for the device to automatically select the recording destination in accordance with the remaining capacity of each HDD.

After the user reserved recording of a specific program, when starting time of this program has come, the HDD controller 111 provides to the recording and playback part 8 instructions for starting recording operation. At this point, the demultiplexer 104, based on a received broadcast signal, supplies the HDD controller 111 with contents data of the program of which the user reserved the recording and program information of this program separately from each other. The HDD controller 111 controls the installed HDD 31 or the cassette HDD 32 to record these data on an individual predetermined sector basis.

To play back a program recorded in the installed HDD 31 or the cassette HDD 32, a list of already recorded programs is displayed on the display 106, and the user views this and selects by using the remote controller or the like the program to be played back. The HDD controller 111 provides the recording and playback part 8 with instructions for starting playback operation of the selected program. The selected program is played back from the installed HDD 31 or the cassette HDD 32, and outputted to the display 106, thus permitting so-called time-shifted viewing.

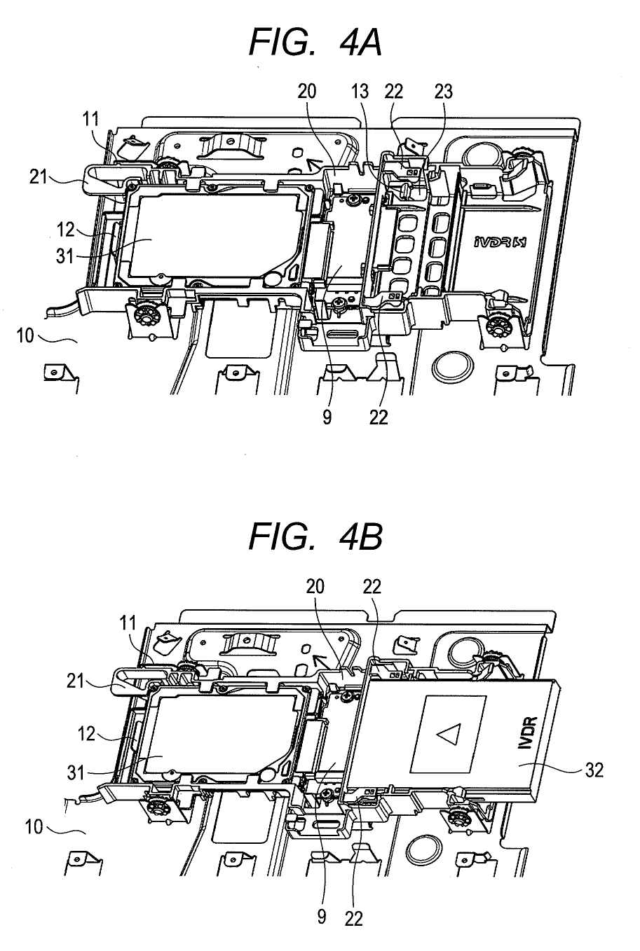

Next, structural characteristics of the recording and playback part 8 of this embodiment will be described. FIGS. 4A and 4B are general views of the surroundings of the recording and playback part 8 of this embodiment. FIG. 4A shows a state in which only the installed HDD 31 is fitted to the recording and playback part 8, and FIG. 4B shows a state in which both the installed HDD 31 and the cassette HDD 32 are fitted thereto. The installed HDD 31 and the cassette HDD 32 are loaded on one tray 20, which is mounted on the main chassis 10. Upon this mounting, the relay board 9 is disposed at the center of the tray 20, and to both sides thereof with connectors in between, the installed HDD 31 and the cassette HDD 32 are fitted oppositely to each other. In conventional structure, a tray holding the installed HDD 31 and a tray holding the cassette HDD 32 are provided separately from each other, but the both trays are integrated in this embodiment. Moreover, for example, flexible wire rods forming the relay board 9, the bus 113, etc. also had to be provided individually, but in this embodiment, they can be shared, thereby reducing the number of components. Mold forming by using as a material of the tray 20 a resin material, for example, PC (polycarbonate), ABS (copolymer synthetic resin of acrylonitrile, butadiene, and styrene), synthetic resin of PC and ABS. PS (polystyrene), or the like achieves an integrated shape.

Further in this embodiment, a screw and a metal part for securing or holding the installed HDD 31 and the cassette HDD 32 fitted to the tray 20 are eliminated, thus further reducing the number of components. That is, the screw conventionally used for securing the installed HDD 31 to the tray 20 is eliminated, and a plate spring used for holding the cassette HDD 32 is eliminated. To this end, the tray 20 and the main chassis 10 are newly structured so that the installed HDD 31 and the cassette HDD 32 do not fall off the tray 20. Hereinafter, characteristics (1) to (5) of the new structure will be described.

(1) An HDD stopper 21 of a hook-like shape integrated with the tray 20 is provided at an end part of the tray 20, thus providing the structure that secures a storage position of the installed HDD 31. In the figure, a left end part (left upper angle) of the installed HDD 31 is pressed by the HDD stopper 21 provided at a left upper corner of the tray 20 to prevent leftward movement of the installed HDD 31. A top surface of the installed HDD 31 is pressed by a tray member, and its right end part is secured to the relay board 9 with the connector. Forming this HDD stopper 21 into a U-shaped folded form as shown in the figure reinforces engagement with the installed HDD 31 when the installed HDD 31 attempts to move leftward, which reinforces stopper action.

(2) To suppress deformation of the HDD stopper 21 provided at the tray 20, part of the main chassis 10 is cut and raised to provide a regulating plate 11. Upon movement of the installed HDD 31 leftward from its original storage position as a result of coming out of the connector for the connection with the relay board 9, the entire HDD stopper 21 is deformed outwardly (upward in the figure), thus resulting in weakened engagement with the installed HDD 31. Thus, providing the regulating plate 11 that suppresses the deformation of the HDD stopper 21 from outside suppresses the deformation of the HDD stopper 21, which permits secure positioning for the installed HDD 31.

(3) To prevent the installed HDD 31 from falling off the tray 20 even under the presence of excessive external force, part of the main chassis 10 is cut and raised to provide an anti-falling plate 12. The anti-falling plate 12 is provided at a position of the main chassis 10 corresponding to a left end part of the tray 20, with a slight distance from the left end part of the installed HDD 31. When excessive external force is added to the installed HDD 31, leftward movement of the installed HDD 31 on the paper surface may not be prevented only with the HDD stopper 21 and the regulating plate 11 described above in some cases. Even in a such case, bringing the end part of the installed HDD 31 to hit against the anti-falling plate 12 can reliably prevent the installed HDD 31 from falling off the tray 20.

(4) To hold the fitted cassette HDD 32 on the tray 20, HDD holders 22 integrated with the tray 20 are provided. The HDD holders 22 press step parts at tips on both surfaces of the cassette HDD 32 from a thickness direction of the cassette HDD 32, thereby preventing the cassette HDD 32 from floating up and falling off the tray 20. Here, the HDD holder 22 is formed integrally with the tray 20 by cutting and raising part of a bottom surface of the tray 20 into a shape of a plate spring. The shape of the HDD holder 22 may be changed as appropriate depending on a shape of the cassette HDD 32 and a portion that presses the cassette HDD. Since the HDD holder 22 is formed by cutting and raising part of the tray 20 (or cutting it out), a hole (opening 23) is formed at a section of the bottom surface of the tray 20 which has been cut and raised.

(5) To prevent foreign substance entry through the opening 23 formed at the bottom surface of the tray 20, part of the main chassis 10 is cut and raised to provide a foreign substance entry prevention plate 13. In a state in which the cassette HDD 32 is not fitted to the tray 20, there is a possibility that a foreign substance enters into a rear side of the tray 20 from outside through the opening 23, causing device failure. For example, the foreign substance is a coin in many cases, and thus some countermeasures are required especially in a case where a size of the opening 23 is larger than a size of the coin (approximately 2 cm). Thus, the foreign substance entry prevention plate 13 formed from the main chassis 10 is so provided as to be placed at a position of the opening 23 of the tray 20 to thereby prevent the foreign substance entry through the opening 23.

In this embodiment as described above, the screw and the metal part for securing or holding the installed HDD 31 and the cassette HDD 32 to be fitted to the tray 20 are eliminated. Then used in placement of the eliminated screw and metal part are: the HDD stopper 21, the regulating plate 11, the anti-falling plate 12, the HDD holders 22, and the foreign substance entry prevention plate 13 formed integrally from the tray 20 or the main chassis 10. This can remarkably reduce the number of components without impairing the function of holding the installed HDD 31 and the cassette HDD 32.

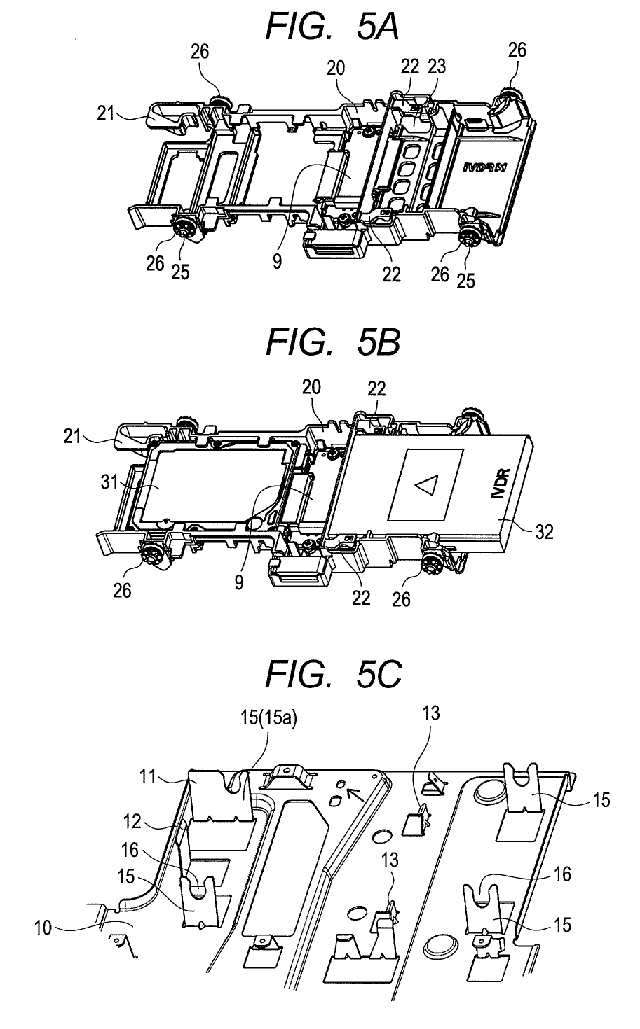

Hereinafter, the characteristic portions described above will be described in more detail with reference to the drawings. FIGS. 5A to 5C are exploded views of the recording and playback part 8. FIG. 5A shows the state in which the relay board 9 is fitted to the tray 20, FIG. 5B shows the state in which the installed HDD 31 and the cassette HDD 32 are fitted to the tray 20, and FIG. 5C shows the shape of the main chassis 10.

Provided at four corners of the tray 20 are: four shafts 25 formed integrally with the tray 20; and dumpers 26 attached to these reflection shafts 25. The dumper 26 is an antivibration elastic body and has a groove at a center in a thickness direction thereof. Further in this embodiment, the HDD stopper 21 for securing the installed HDD 31 and the HDD holders 22 for holding the cassette HDD 32 are formed integrally. The openings 23 are the holes formed upon the integral formation of the HDD holders 22.

To the both sides of the tray 20, the installed HDD 31 and the cassette HDD 32 are fitted with the relay board 9 sandwiched therebetween. Upon this fitting, the installed HDD 31 and the cassette HDD 32 are secured at predetermined positions with the end part of the installed HDD 31 pressed by the HDD stopper 21 and the end parts of the cassette HDD 32 pressed by the HDD holders 22 from the thickness direction of the cassette HDD 32.

On the main chassis 10, four holders 15 for supporting the tray 20 are formed by cutting and raising at a substantially right angle, and a groove 16 of a U-shape is formed at each of the holders 15. By inserting the dumpers 26 of the tray 20 into the U-shaped grooves 16, the tray 20 is secured to the main chassis 10. The number of holders 15 and the shape of the U-shaped groove 16 are not limited to those described above, and thus the number of holders 15 can be increased to six and an entry of the U-shaped groove 16 can be narrowed down to structure the dumper 26 that hardly comes off.

Further, formed integrally with the main chassis 10 of this embodiment are: the regulating plate 11 that suppresses the deformation of the HDD stopper 21; the anti-falling plate 12 that prevents the fall-off of the installed HDD 31; and the foreign substance entry prevention plates 13 that prevents the foreign substance entry through the openings 23. Since the regulating plate 11 is located closely to one holder 15a, it is formed by extending the holder 15a, but it may be provided separately therefrom. The regulating plate 11 is arranged at a position slightly distant from the outside of the HDD stopper 21, the anti-falling plate 12 is arranged at a position slightly distant from the end part of the installed HDD 31, and the foreign substance entry prevention plate 13 is so formed as to be placed at the position of the opening 23.

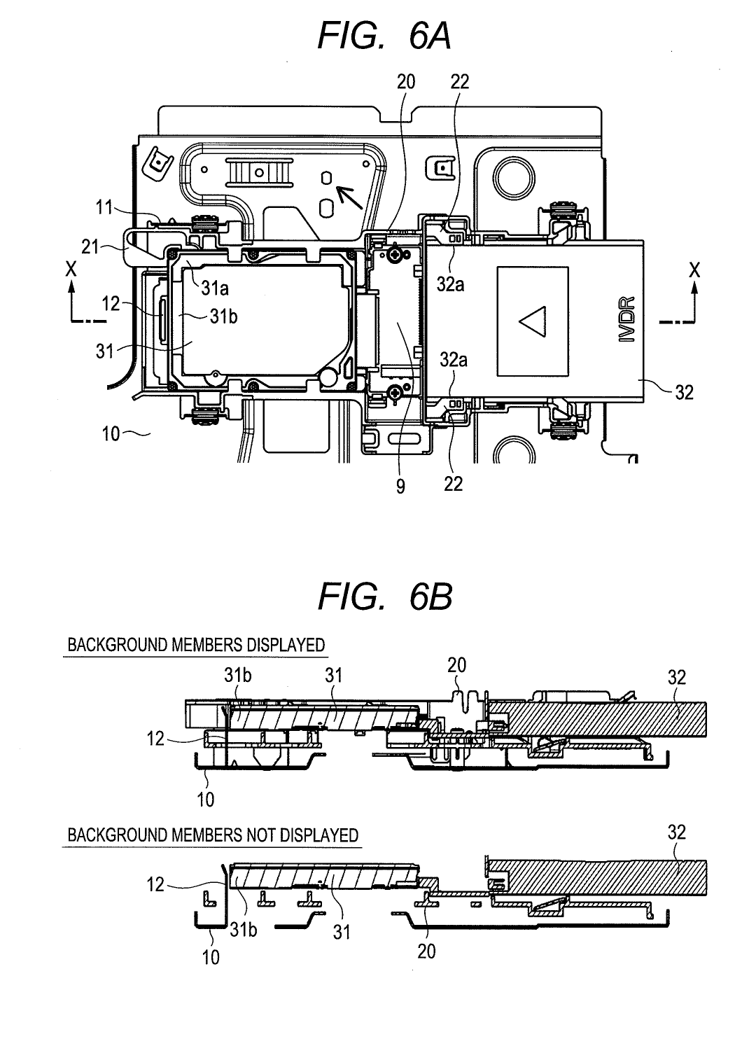

FIGS. 6A and 6B are diagrams illustrating anti-falling of the installed HDD 31 and the cassette HDD 32. FIG. 6A is a plan view of the recording and playback part 8, and FIG. 6B shows sectional views taken along line X-X of FIG. 6A. In the sectional views of FIG. 6B, one of the views with background members displayed and the other view with the background members not displayed are illustrated separately for easier understanding.

For the installed HDD 31, the fall-off the tray 20 is prevented by the HDD stopper 21, the regulating plate 11, and the anti-falling plate 12. The HDD stopper 21 presses a corner part 31a of the installed HDD 31, thereby preventing the installed HDD 31 from moving leftward in the figure. The regulating plate 11 suppresses the deformation of the HDD stopper 21 in an upward direction in the figure, thereby securing the installed HDD 31 at the predetermined position. The anti-falling plate 12 is provided at a position slightly distant from an end part 31b of the installed HDD 31, thus preventing the installed HDD 31 from falling off the tray 20 even when excessive external force is added to the installed HDD 31.

For the cassette HDD 32, step parts 32a at the tips on the side surfaces of the cassette HDD 32 are pressed by the two HDD holders 22, thereby preventing fall-off the tray 20.

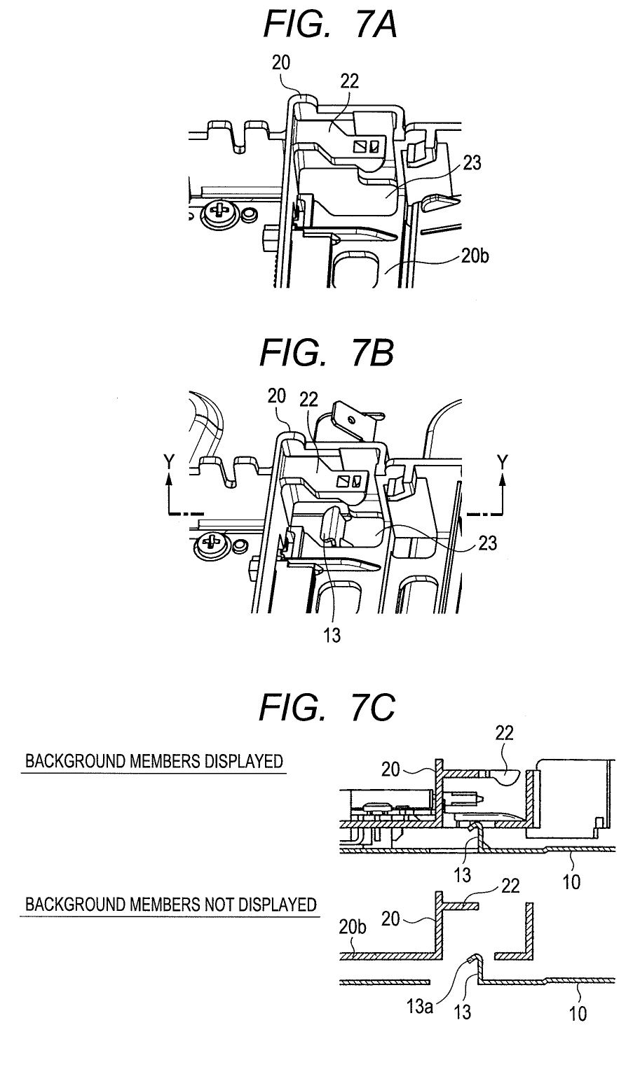

FIGS. 7A to 7C are diagrams illustrating the prevention of the foreign substance entry into the tray 20. FIG. 7A is a perspective view of a portion of the tray 20 where the tip of the cassette HDD 32 is fitted, FIG. 78 is a perspective view of the tray 20 of FIG. 7A attached to the main chassis 10, and FIG. 7C shows sectional views taken along line Y-Y of FIG. 7B. In the sectional views of FIG. 7C, one of the views with background members displayed and the other view with the background members not displayed are illustrated separately for easier understanding.

At the tray 20, the HDD holder 22 for holding the cassette HDD 32 is integrally formed. Thus, the opening 23 is formed at the bottom surface 20b of the tray 20, and in this condition, there is a risk of foreign substance entry from the outside when the cassette HDD 32 is not fitted. Thus, part of the main chassis 10 is cut and raised to form the foreign substance entry prevention plate 13, thereby covering the opening 23. This prevents the entry of a foreign substance such as a coin through the opening 23. The foreign substance entry prevention plate 13 is formed at a substantially central part of the opening 23, but its height is brought into agreement with that of the bottom surface 20b of the tray 20 so that the foreign substance entry prevention plate 13 does not become an obstacle upon the fitting of the cassette HDD 32. Moreover, a tip end 13a of the foreign substance entry prevention plate 13 is formed into a bent shape to thereby further reduce an area of the opening 23, enhancing effect of the foreign substance entry prevention.

The embodiment described above is just one example, and thus the invention is not limited thereto. The new characteristics (1) to (5) related to the tray 20 and main chassis 10 described above are effective either individually or in combination when appropriate. Moreover, a recording medium fitted to the recording and playback part 8 is not limited to an HDD, and thus for example, an optical disc drive may be fitted. These recording media are applicable in either an installed type or an attachable and detachable type. Further, the invention is applicable not only to a video display device that displays a video but also to a video recording and playback device, such as an HDD recorder, without a video display.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and medications that fall within the ambit of the appended claims.

What is claimed is:

1. A video display device displaying an inputted video signal at a display and also having a recording and playback part recording and playing back the inputted video signal, the video display device comprising:
a tray integrally storing as the recording and playback part a first recording medium built in the device and a second recording medium attachable to and detachable from the device; and
a main chassis having a processing board for the video signal mounted thereon together with the tray, wherein:
a stopper of a hook-like shape integrated with the tray is provided at an end part of the tray; and
an end part of the first recording medium is pressed by the stopper to secure a storage position of the first recording medium.

2. The video display device according to claim 1, wherein:
part of the main chassis is cut and raised to provide a regulating plate; and
deformation of the stopper provided at the tray is suppressed by the regulating plate.

3. The video display device according to claim 1, wherein:
part of the main chassis is cut and raised to provide an anti-falling plate; and
the first recording medium stored on the tray is prevented by the anti-falling plate from falling off the tray.

4. The video display device according to claim 1, wherein:
a holder integrated with the tray is provided at the tray; and
a side surface at an end part of the second recording medium is pressed by the holder to prevent the second recording medium from falling off the tray.

5. The video display device according to claim 4, wherein:
the holder provided at the tray is formed integrally by cutting and raising a bottom surface of the tray;
for an opening formed as a result of the cutting and raising, part of the main chassis is cut and raised to provide a foreign substance entry prevention plate; and
the opening is covered with the foreign substance entry prevention plate.

6. The video display device according to claim 1, wherein
the first recording medium is an installed HDD and the second recording medium is a cassette HDD.

7. A video display device displaying an inputted video signal at a display and also having a recording and playback part recording and playing back the inputted video signal, the video display device comprising:
a tray integrally storing a recording medium built as the recording and playback part in the device; and
a main chassis having a processing board for the video signal mounted thereon together with the tray, wherein:
a stopper of a hook-like shape integrated with the tray is provided at an end part of the tray; and
an end part of the recording medium is pressed by the stopper to secure a storage position of the recording medium.

8. The video display device according to claim 7, wherein
part of the main chassis is cut and raised to provide a regulating plate; and
deformation of the stopper provided at the tray is suppressed by the regulating plate.

9. The video display device according to claim 7, wherein:
part of the main chassis is cut and raised to provide an anti-falling plate; and
the recording medium stored on the tray is prevented by the anti-falling plate from falling off the tray.
